(19) United States
(12) Patent Application Publication
(10) Pub. No.: US 2006/0164005 A1
(43) Pub. Date: Jul. 27, 2006

(54) Illumination apparatus having adjustable color temperature and method for adjusting the color temperature

(76) Inventor: Chuan-Sheng Sun, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/041,735

(22) Filed: Jan. 25, 2005

(51) Int. Cl. H01J 1/62

(52) U.S. Cl. 313/503

(57) ABSTRACT

An illumination apparatus having adjustable color temperature and a method for adjusting the color temperature. The apparatus and the method can adjust the color temperature for different purposes. The illumination apparatus comprises: a blue-light source; a transparent filter lens set on the top of the blue-light source; a fluorescence layer of cerium-doped yttrium aluminum garnet (YAG) phosphor is spread onto the transparent filter lens. Replacing the yttrium and the aluminum in the cerium-doped yttrium aluminum garnet phosphor with gadolinium (Gd) and gallium (Ga) respectively can produce yellow lights of different wavelengths. Different yellow lights can then be mixed with the blue light to produce white lights of different color temperature.

### BACKGROUND OF THE INVENTION

1. Field of the Invention

The present invention is related to an illumination apparatus having adjustable color temperature and a method for adjusting the color temperature, and specifically relates to an apparatus using different lenses with different phosphors respectively to emit light of various color temperatures.

2. Description of Related Art

Humans see the colors of objects by means of the light the objects reflect. When the brightness of the light is sufficient, clear and sharp colors can be seen. Equally, the colors of the objects disappear when the light is insufficient. Additionally, psychologically, light may appear to have warm or cold qualities. Color temperature is used to describe the light just like chroma is used for presenting colors. A low color temperature of light is suitable for use on products with a warm and soft atmosphere such as wood, carpet or cotton material. Conversely high color temperatures will create a cold or quite atmosphere and is useful in areas with hot weather.

Color temperature is defined by absolute temperature K. When a standard black body is heated to a certain temperature, the color of the black body changes gradually in the following sequence: deep red, shallow red, orange, yellow, and finally blue. The light of the light source is the same as with the light of the black body, and the color temperature of the source is determined by the absolute temperature of the black body at that time.

When the color temperature is 3000 K, it generates a warm and comfortable feeling suitable for hotels or residences; a color temperature of 4000K-5000K will present a tender white light and is suitable for offices or schools; a color temperature of 5000K presents cold day light and is suitable for use in industries such as printing, textiles and dyeing.

However, prior art illumination apparatuses cannot change the color temperature for different applications. In order to adjust the color temperature, the prior art provides two methods. The first projects white light onto color filter lenses for producing different color temperatures. U.S. Pat. No. 6,755,555 B2 entitled “Auxiliary illuminating device having an adjustable color temperature by controlling the amount of light passing through color filters” sets different color filter lenses in front of the light source for adjusting the color temperature.

Nevertheless, the above-mentioned method needs a good light-mixing device for mixing the light filtered by the color filter lens. Otherwise any changes may only occur in the color of the light, not in the color temperature. Furthermore, this method requires a lot of filter lenses, increasing the weight and the volume of the illumination apparatus. Moreover, the method needs a white light source. These white light sources produce a great quantity of heat and their emitting diodes are expensive and light emitted from the diode is of a limited brightness.

The other method sets two different light sources inside an illumination device and mixes two different lights for producing different color temperatures. U.S. Pat. No. 6,379,022 entitled, “Auxiliary illuminating device having adjustable color temperature” uses a light source that displays at least two colors. The light source typically uses at least one set of LEDs.

The drawback of the above mentioned method is that using two light sources increases the volume and the cost of the apparatus. Alternatively, a control circuit can also be used, but this also increases costs.

### SUMMARY OF THE INVENTION

The main objectives of the present invention are to provide an illumination apparatus having adjustable color temperature and a method for adjusting the color temperature. The present invention provides a smaller illumination apparatus that allows the color temperature to be changed for according to the user's needs. The present invention also provides an adjusting method to change the color temperature.

To achieve the first objective, an illumination apparatus having adjustable color temperature comprises: a blue-light source; and a transparent filter lens set on the top of the blue-light. Additionally, a fluorescence layer of cerium-doped yttrium aluminum garnet (YAG) phosphor is spread onto the transparent filter lens.

To achieve the second objective, a method for adjusting color temperature includes the following steps: providing a blue-light source; providing a transparent filter lens; forming a fluorescence layer inside the transparent filter lens; wherein the fluorescence layer is composed of cerium-doped yttrium aluminum garnet, and the transparent filter lens is set above the blue-light source.

To provide a further understanding of the invention, the following detailed description illustrates embodiments and examples of the invention, this detailed description being provided only for illustrating the invention.

### BRIEF DESCRIPTION OF THE DRAWINGS

FIG. 1 shows an exploded diagram of an illumination apparatus having color temperature of the present invention;

FIG. 2 shows a schematic diagram of a fluorescence layer formed by double shot injection on a transparent filter lens;

FIG. 3 is a perspective view of another embodiment of the transparent filter lens;

FIG. 4 shows a lateral exploded view of another embodiment of the present invention;

FIG. 5 shows a perspective view of a third embodiment of the transparent filter lens;

FIG. 6 shows a perspective view of a fourth embodiment of the transparent filter lens;

FIG. 7 shows a perspective view of a fifth embodiment of the transparent filter lens.

### DETAILED DESCRIPTION OF PREFERRED EMBODIMENTS

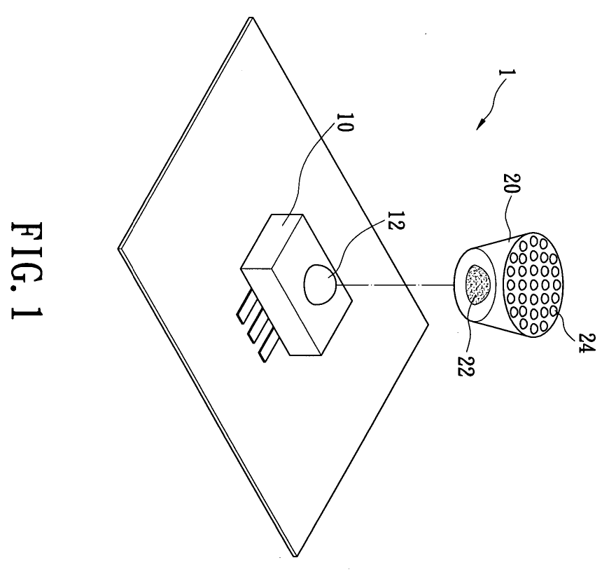

Please refer to FIG. 1 showing an exploded diagram of an illumination apparatus having adjustable color temperature of the present invention. The illumination apparatus 1 having adjustable color temperature comprises a blue-light source 10 and a transparent filter lens 20. The blue-light source is a blue light emitting diode of high intensity—greater than 1 W. Of course the blue-light source may also be a laser source or a light bulb.

The transparent filter lens 20 is set above the blue-light source, wherein a fluorescence layer 22 of cerium-doped yttrium aluminum garnet (YAG) phosphor covers the transparent filter lens 20. Furthermore, blue light will stimulate the cerium-doped yttrium aluminum garnet (YAG) phosphor to emit yellow light. The yellow light is then mixed with blue light to produce white light. The present invention uses yttrium aluminum garnet (YAG) phosphor with different components for stimulating yellow lights of different wavelengths, wherein the yellow light can change to red or blue light. Therefore blue light can be mixed with yellow lights of different wavelengths to produce light of a specific color temperature. Moreover, different color temperatures can be made by changing the different transparent filter lenses 20.

An embodiment of the present invention replaces the aluminum and the yttrium in the cerium-doped yttrium aluminum garnet phosphor with gadolinium (Gd) and gallium (Ga), respectively, for emitting yellow light with different wavelengths. Wherein the chemical formula is (Y_{2.95-a} Ce_{0.05} Gdₐ) (Al_{5-b}Ga_{b})O₁₂; the symbol “a” has a value of between 0 and 3, and “b” is valued between 0 and 5. In addition, the chromaticity coordinate of the phosphor is positioned at the yellow light section. When the value of “a” is increased, the chromaticity coordinates move towards the red light area and the color temperature of the light is lowered. On the other hand, with the increasing value of “b”, the chromaticity coordinate moves towards the blue light area and the color temperature of the light is higher. However, when the value of “a” is over 1.8, the phase of the light becomes complicated and the light intensity is attenuated to zero when the value of “b” is over 4.

The above-mentioned method for changing the wavelength of the light is not defined in the appended claims. The embodiment is not restricted to replacing yttrium and aluminum with gadolinium (Gd) and gallium (Ga)—the structure of the phosphor may also be replaced by terbium (Td) and europium (Eu) for emitting green light and red light respectively. When the yttrium in the cerium-doped yttrium aluminum garnet phosphor is replaced with europium (Eu), the wavelength of the highest intensity of the emitting light is around 590 nm.

The present invention also provides a convenient production process as a production factory only needs to set different transparent filter lenses 20 on the blue-light source 10 to generate light with different color temperatures, wherein the filter lenses are covered by different phosphors. Because of this, a top part 12 of the blue light source 10 condenses light and the curvature at the bottom of the transparent filter lens 20 corresponds to the curvature of the top part 12 of the blue-light source 10. Moreover, the fluorescence layer 22 is preferably set at the bottom of the transparent filter lens 20 for mixing the light for the best achievable results. Furthermore, the fluorescence layer 22 is spread onto the transparent filter lens, this method being suitable for transparent filter lenses with flat bottoms.

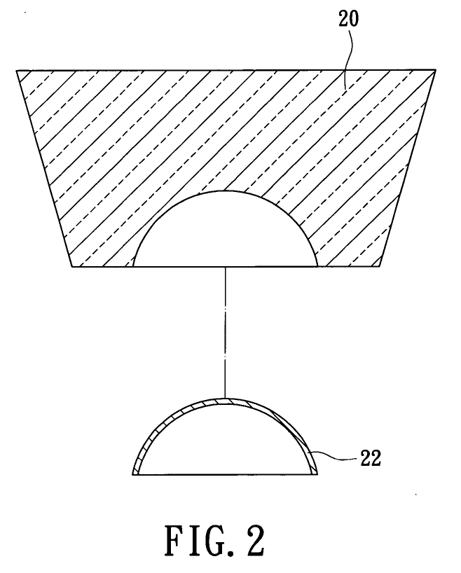

FIG. 2 shows a schematic diagram of a fluorescence layer formed by double shot injection on a transparent filter lens. The transparent filter lens 22 is an arc. Therefore, the fluorescence layer 22 is formed at the bottom of the lens by using the double shot injection technique. The double shot injection technique uses two different colors of plastic materials to make plastic products with two colors. Hence, the processes of packaging and processing the plastic products are simplified. Moreover, the present invention adds phosphor into the plastic materials. The phosphor is then be injected precisely with melted plastic material to form a fluorescence layer at the bottom of the transparent filter lens 20. Therefore, the cambered surface of the fluorescence layer 22 is attached onto the surface of the blue-light source 10 accurately.

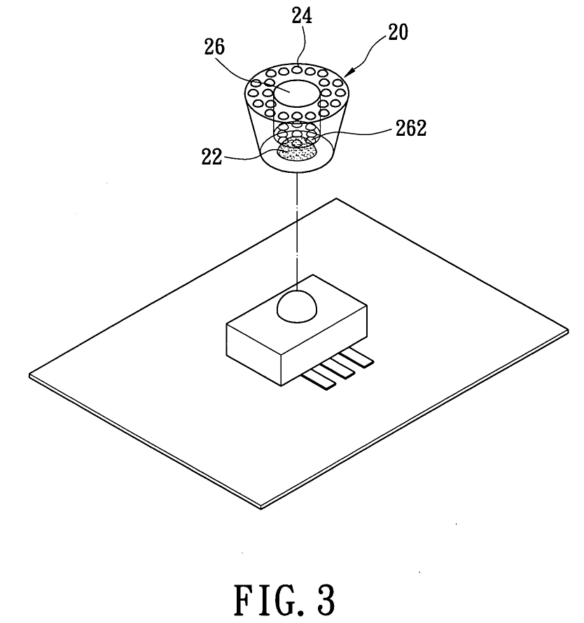

Please refer to FIG. 1 showing the present invention formed integrally with a plurality of protruding parts 24 on the top part of the transparent filter lens 20 for further mixing and condensing light. Please also refer to FIG. 3 which is a perspective view of another embodiment of the transparent filter lens 20. The transparent filter lens 20 of the embodiment further includes a pillared concave groove 26 and a plurality of protruding parts 262 formed at the bottom of the pillared concave groove 26, wherein the protruding parts 262 are above the fluorescence layer 22. Hence, the protruding parts 262 are closer to the fluorescence layer 22 so that a better mixture of light can be attained.

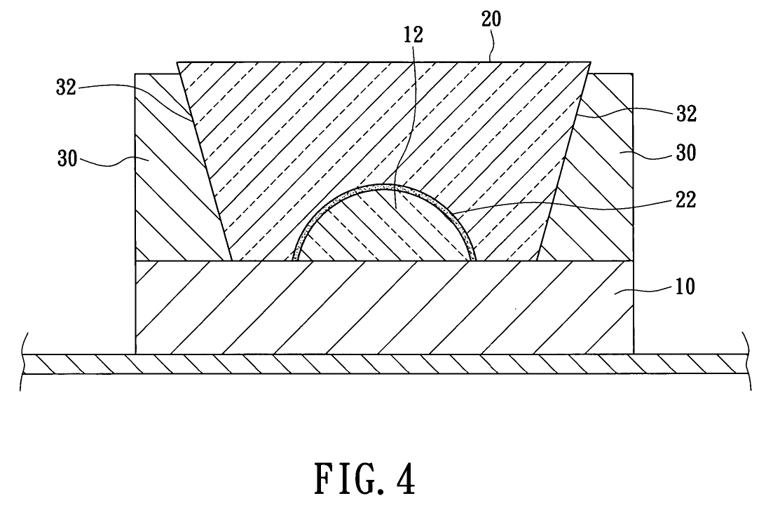

Please refer to FIG. 4 showing a lateral exploded view of another embodiment of the present invention. A reflective element 30 is set around the transparent filter lens 20 to increase the light's condensing ability. The reflection element 30 can be made of metal or other materials. Additionally, a reflective layer 32 can be coated onto the internal side of the reflective element 30.

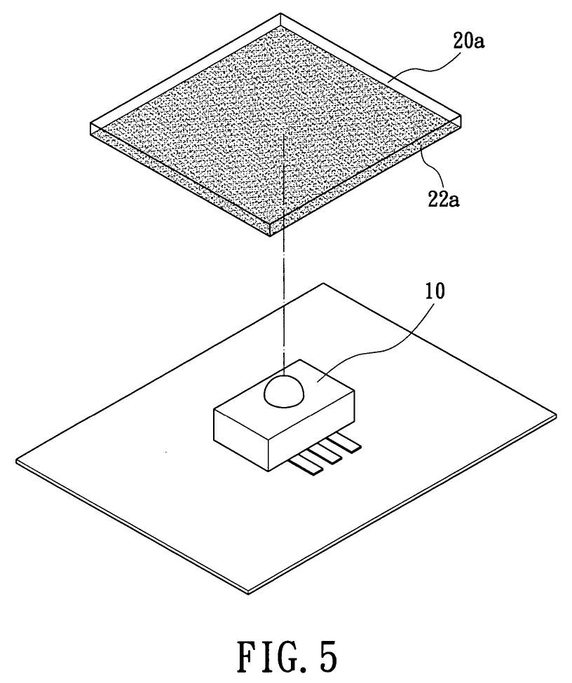

FIG. 5 is a perspective view of a third embodiment of the transparent filter lens. In this embodiment, the appearance of the transparent filter lens 20 is changeable. For example, a flat transparent filter lens 20a of the embodiment has a fluorescence layer 22a on its bottom. Meanwhile, the flat transparent filter lens 20a can be a cover with various patterns for instruction lights, such as those used for fire exit lights. The appearance of the light emitting diode 10 is also changeable. For example, the top part of the diode may be flat.

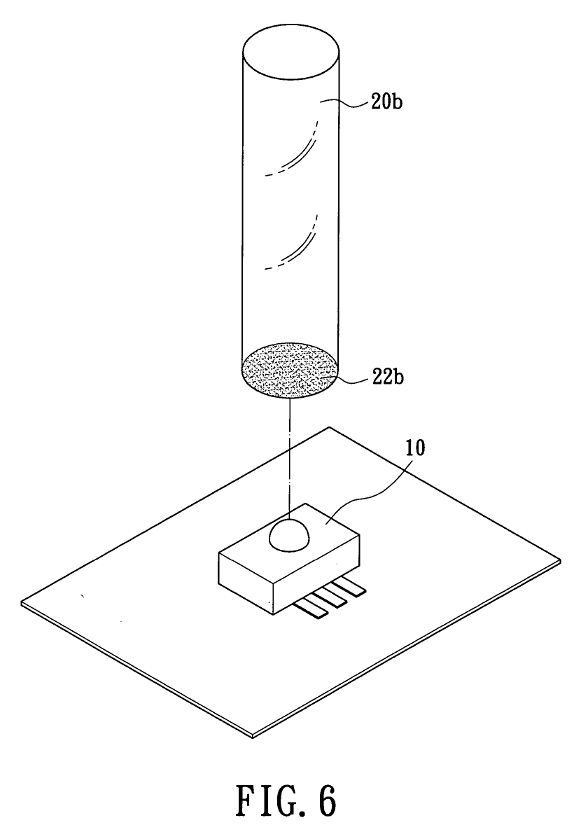

FIG. 6 is a perspective view of a fourth embodiment of a transparent filter lens. In this embodiment, the transparent filter lens is a pillared transparent lens 20b with a fluorescence layer 22a set at the bottom of the lens. This embodiment can be used for instruction lights such as buttons in an elevator.

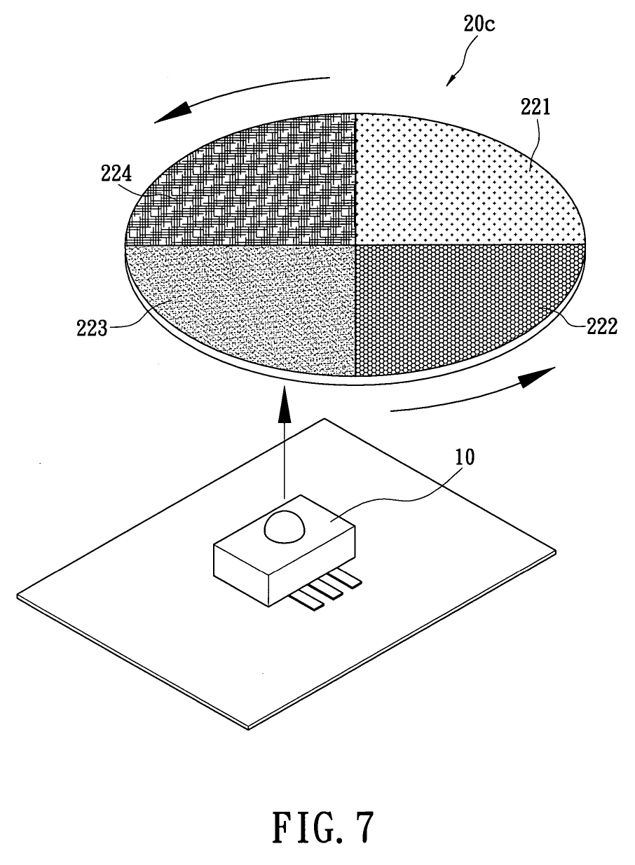

FIG. 7 is a perspective view of a fifth embodiment of the transparent filter lens. In this embodiment, the transparent filter lens is a rotatable round plate lens 20c which is divided into four sections. The four different fluorescence layers 221, 222, 223 and 224 have different gallium/gadolinium ratios of cerium-doped yttrium aluminum garnet (YAG) phosphor. Therefore, users can adjust the color temperature of the light directly.

The present invention provides a method for the adjusting color temperature and includes the following steps: providing a blue-light source; providing a transparent filter lens; forming a fluorescence layer inside the transparent filter lens, wherein the fluorescence layer is composed of cerium-doped yttrium aluminum garnet, and the transparent filter lens is set above the blue-light source.

The method further adjusts the curvature of the bottom of the transparent filter lens to correspond to the curvature of the top of the blue-light source.

The method further sets a fluorescence layer at the bottom of the transparent filter lens using the double shot injection technique.

The method further replaces the yttrium and the aluminum in the cerium-doped yttrium aluminum garnet phosphor with gadolinium (Gd) and gallium (Ga).

The method further sets a reflection element around the transparent filter lens.

The present invention produces a white light of different color temperatures without using a plurality of filter lenses and light sources. The characteristics and functions are as following:
1. The present invention replaces transparent filter lenses composed of different phosphors that are used with a blue-light source. Different color temperatures are thereby produced while the production process is simple and convenient, and the volume of the illumination apparatus is not increased.
2. The transparent filter lenses with various appearances are covered and stuck on the blue-light source for wide-ranging purposes. They are also more convenient as they are easily replaceable.
3. By changing the components of the phosphor on the transparent filter lenses, the present invention precisely produces yellow lights of different wavelengths. The color temperature is thus controlled easily, and packaging as well as production of the apparatus is also simplified.

There has thus been described a new, novel and heretofore unobvious illumination apparatus which eliminates the aforesaid problem in the prior art. Furthermore, those skilled in the art will readily appreciate that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. An illumination apparatus having adjustable color temperature, comprising:
a blue-light source;
a transparent filter lens set on the top of the blue-light having a fluorescence layer of cerium-doped yttrium aluminum garnet (YAG) phosphor spread onto the transparent filter lens.

2. The illumination apparatus having adjustable color temperature as in claim 1, wherein the blue-light source is a blue light emitting diode.

3. The illumination apparatus having adjustable color temperature as in claim 1, wherein the blue-light source is a blue light emitting diode with power greater than 1 watt.

4. The illumination apparatus having adjustable color temperature as in claim 1, wherein the yttrium in the cerium-doped yttrium aluminum garnet phosphor is replaced with gadolinium (Gd) for emitting yellow light deviated to red light.

5. The illumination apparatus having adjustable -color temperature as in claim 1, wherein the aluminum in the cerium-doped yttrium aluminum garnet phosphor is replaced with gallium (Ga) for emitting yellow light deviated to blue light.

6. The illumination apparatus having adjustable color temperature as in claim 1, wherein the curvature at the bottom of the transparent filter lens corresponds to the curvature at the top of the blue-light source.

7. The illumination apparatus having adjustable color temperature as in claim 1, wherein the fluorescence layer is set at the bottom of the transparent filter lens.

8. The illumination apparatus having adjustable color temperature as in claim 1, wherein the fluorescence layer set at the bottom of the transparent filter lens is made using a double shot injection technique.

9. The illumination apparatus having adjustable color temperature as in claim 1, wherein a plurality of protruding parts is set on the top part of the transparent filter lens.

10. The illumination apparatus having adjustable color temperature as in claim 1, wherein the transparent filter lens further includes a pillared concave groove, and a plurality of protruding parts is formed at the bottom of the pillared concave groove. The protruding parts are also above the fluorescence layer.

11. The illumination apparatus having adjustable color temperature as in claim 1, wherein a reflection element is set around a transparent filter lens.

12. The illumination apparatus having adjustable color temperature as in claim 1, wherein the transparent filter lens is a flat lens.

13. The illumination apparatus having adjustable color temperature as in claim 1, wherein the transparent filter lens is a pillared lens.

14. The illumination apparatus having adjustable color temperature as in claim 1, wherein the transparent filter lens is a rotatable round plate lens with a plurality of sections. The sections include different components in the fluorescence layer of the yttrium aluminum garnet phosphor.

15. A method for adjusting the color temperature, including the following steps:
providing a blue-light source;
providing a transparent filter lens;
forming a fluorescence layer inside the transparent filter lens;
wherein the fluorescence layer is composed of cerium-doped yttrium aluminum garnet, and the transparent filter lens is set above the blue-light source.

16. The method for adjusting the color temperature as in claim 15, further adjusting the curvature at the bottom of the transparent filter lens to correspond to the curvature at the top of the blue-light source.

17. The method for adjusting the color temperature as in claim 15, further setting a fluorescence layer at the bottom of the transparent filter lens using the double shot injection method.

18. The method for adjusting the color temperature as in claim 15, further setting a reflection element around the transparent filter lens.

19. The method for adjusting the color temperature as in claim 15, further replacing the yttrium in the cerium-doped yttrium aluminum garnet phosphor with gadolinium (Gd).

20. The method for adjusting the color temperature as in claim 15, wherein further replacing the aluminum in the cerium-doped yttrium aluminum garnet phosphor with gallium (Ga).
